(19) United States
(12) Patent Application Publication
(10) Pub. No.: US 2025/0200433 A1
(43) Pub. Date: Jun. 19, 2025

(54) SYSTEMS AND METHODS FOR DETECTING RECURRENT PATTERNS IN TIME SERIES DATA FOR TUNING MACHINE LEARNING MODELS

(71) Applicant: THE BANK OF NEW YORK MELLON, New York, NY (US)

(72) Inventors: Ajay NATHANI, New York, NY (US); Abhinav PRASAD, New York, NY (US); Ali MOTAMEDI, New York, NY (US); Manish JAIN, New York, NY (US); Shubham AGNIHOTRI, New York, NY (US)

(21) Appl. No.: 18/598,765

(22) Filed: Mar. 7, 2024

(30) Foreign Application Priority Data
Dec. 16, 2023 (IN) 202321086015

(51) Int. Cl. G06N 20/00; G06N 7/01

(52) U.S. Cl. CPC G06N 20/00; G06N 7/01

(57) ABSTRACT

The disclosure relates to systems and methods of detecting recurrent patterns such as seasonality in time series data to improve the forecasting performance of machine learning models. The time series data may be encoded into interval encodings that capture recurrent patterns that may occur at certain time periods that would otherwise not be detected. To perform frequency-based analysis, the intervals may be converted to numeric values, then decomposed from a time domain to a frequency domain to form frequency components such as sine and cosine waves. Relevant frequency components that are influential are identified through Monte Carlo Markov Chain analysis and/or Gaussian Mixture Model analysis. The identified frequency components may represent recurrent patterns detected in the time series data and are used to configure an order value that defines the number of frequency components used for future decomposition and analysis for forecasting.

### CROSS-REFERENCE TO RELATED APPLICATIONS

This application claims priority to India patent application No. 202321086015, filed Dec. 16, 2023, the subject matter of which is incorporated herein by reference in entirety.

### BACKGROUND

Machine learning models may be trained to learn relationships from datasets. In the context of time series data, machine learning models may learn relationships in the time series data to predict future values. However, time series data may exhibit various characteristics that can impact future values in the time series. These characteristics may include one or more trends, autoregressive behavior, influence from exogenous variables, and/or other factors that can impact future values in the time series. Machine learning models trained on time series data may be sensitive to changes related to one or more of these characteristics that are unaccounted for during training and modeling, leading to prediction error. These and other issues exist with machine learning models to forecast time series data.

### SUMMARY

Various systems and methods may address the foregoing and other problems. One of the previously mentioned characteristics that can influence the time series data may include recurrent patterns, such as seasonality. The existence of one or more recurrent patterns may be unknown. Furthermore, the magnitude of a given recurrent pattern can be an important driver of time series data, but this importance may be difficult to detect due to noise and changing nature of time series data. Detecting and incorporating recurrent patterns to fine-tune machine learning models may improve the performance of these models.

In some implementations, a system may be improved to detect recurrent patterns by decomposing the time series data from a time domain to a frequency domain to generate a frequency-based signal having frequency components. The system may then perform signal processing to identify recurrent patterns in the frequency-based signal. For example, the system may derive frequency-based features derived from the frequency-based signal and train machine learning models using the frequency-based features to forecast future values of time series data.

Signal processing on decomposed time series data may introduce various problems in detecting certain recurrent patterns. For example, some recurrent patterns may occur at specific time periods such as at the beginning or end of the month. However, if the input or training time series data is analyzed in weekly intervals that do not begin and/or end at a given month, then these recurrent patterns may go undetected because a weekly interval may span the end of one month and the beginning of the next month. This weekly interval may reduce the signal of a recurrent pattern that may occur at the end or beginning of the spanned months due to the noise at the other end of the pattern. For instance, if there is a recurrent pattern at the end of January, a weekly interval that spans the end of January and the beginning of February would degrade the signal of the data for the end of January because of the noise from the data for the beginning of February in the weekly interval. In this scenario, the recurrent pattern at the end of January may go undetected (or at least its significance may be underfitted). Similar issues may arise with other recurrent patterns that exist at time periods other than the beginning or end of month with other time intervals that span both time periods in time series data.

To address this problem, the system may define intervals of the time series data that improve sensitivity of detecting recurrent patterns around certain time periods. In particular, the system may define intervals of the time series data to ensure that the beginning and end of each higher-order interval are taken into account, improving the sensitivity of detecting recurrent patterns around these times periods. For example, the system may define an initial lower-level interval of a higher-level interval to start at the beginning of a higher-level interval and end at the ending of the higher-level interval. These defined lower level intervals will be referred to as interval encodings. To illustrate, the system may define an initial weekly interval for January (a “weekly encoding”) to start at the beginning of January and an ending weekly interval (another “weekly encoding”) to end at the end of January. The system may generate weekly intervals for weeks in the middle of the month and repeat this encoding process for the remaining months. The time series data may therefore be encoded in a way that downstream signal processing is able to detect recurrent patterns that may occur at the beginning, middle, or end of the month or other higher-level intervals.

Another issue with signal processing on decomposed time series data may arise due to the nature of some time series data. In particular, when the time series data is based on a calendar or fiscal year, the periodicity of frequency-based signals in a calendar-based time domain may be skewed due to irregularities in the way these time domains store data, making recurrent pattern detection inaccurate. For example, because a calendar year is 365.25 days, a periodicity of one year may be difficult to model when the time series data is stored according to the calendar year in, for example, weekly intervals. Other issues can arise in periodicities other than a year and/or time intervals other than weekly intervals.

To address this problem, the system may convert each date-based value (such as the weekly encodings) to a numeric value. The system may then use the numeric value to define units of periodicity for frequency-based signal processing. These units of periodicity may improve the predictive performance of the frequency components because each frequency component may be used to compare and analyze the value at the beginning of a unit of periodicity and the end of the unit of periodicity. For example, if one year is used for recurrent pattern detection, the system may use a given frequency component to analyze year-to-year correlations in a change of values over time, which may indicate recurrent patterns, such as seasonal effects on the time series data that occur at approximately the same time every year.

Another issue that may arise when performing signal processing on decomposed time series data may include selecting an appropriate value for an order of frequencies. The order of frequencies is associated with an arrangement of the frequency components extracted from decomposition of the time series data. In particular, the order of frequency may be parameterized as an order value (also referred to as “N_order”), which may be an integer value that represents the number of frequency components that are considered most relevant and influential in shaping the time series patterns and/or a sequence of numbers that represent the order of specific frequencies. For example, if the top ten most prominent frequency components are used, the order value can be defined as the number ten (N_order=10).

The system may determine an order of frequencies to use, which may improve performance of recurrent pattern detection. For example, the system may start with a default value for the order of frequencies and then fine-tune the default value to generate a fine-tuned order of frequencies value. To do so, the system may adjust the default value of the orders of frequency (the most relevant frequency components) through random sampling and statistical averaging. For instance, the system may use a Monte Carlo Markov Chain (MCMC) to select the most relevant frequency components from the Fourier transform spectrum and adjust the order of frequency value accordingly. In particular, the system may iteratively generate a chain of random samples, converging towards the distribution of the frequency component magnitudes. From the generated samples, the system may identify the most significant frequency components.

Once the relevant frequency components are identified, the system may apply statistical averaging to each of the relevant frequency components to smooth out noise and improve the signal-to-noise ratio. This may involve averaging the values of each frequency component within a specific time window or frequency range. The system may convert the averaged frequency components back to the time domain to reconstruct the time series. In particular, the system may recombine the averaged frequency components using an inverse Fourier transform to reconstruct the time series data. By doing so, the system may synthesize smoothed frequency components back into the time domain, generating a smoothed and noise-reduced time series. The system may then use the smoothed time series for forecasting. For example, the system may apply a machine learning model trained to predict future values. The machine learning model may include a base version of the PROPHET model, an autoregressive integrated moving average (ARIMA) model, an exponential smoothing model, or others that may use the smoothed time series to predict future values.

Once the forecasted values are generated, the system may assess the performance of the forecasted values based on a similarity metric to actual values in the time series. The similarity metric may provide an estimate of the accuracy of the forecast. This estimate may be presented alongside the forecast and/or be used to further fine-tune the order of frequency value or other values that may impact forecasting.

For example, to generate the similarity metric, the system may calculate an angle similarity metric based on the Mean Absolute Error (“MAE”) between the angle of weekly change for the actual values (ϕ_{A}) and the angle of weekly change for the forecasted values (ϕ_{F}). This MAE will be referred to as MAE (ϕ_{A}, ϕ_{F}). Similarly, the system may calculate a directional similarity metric based on the directionality of (ϕ_{A}, ϕ_{F}) according to the function: Count_Match (Dir(ϕ_{A}), Dir(ϕ_{F})) in which matches in directionality between the direction of weekly change of actual values matches the direction of weekly change of forecasted values. The system may use the MAE (ϕ_{A}, ϕ_{F}) and Count_Match (Dir(ϕ_{A}), Dir(ϕ_{F})) similarity metrics to measure similarity between actual and forecasted values. Put another way, the similarity metrics may provide an estimate of the performance, or error of the forecasted values, in which higher similarity is associated with lower error and vice versa.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system for forecasting time series data based on real-world recurrent pattern detection, according to an implementation.

FIG. 2 illustrates a plot showing an example of a periodicity of time series data, according to an implementation.

FIG. 3 illustrates a plot showing an example of a periodicity of time series data having date values converted to non-date numeric values to generate waveform components that improve recurrent pattern for forecast modeling, according to an implementation.

FIG. 4A illustrates a plot showing an example of actual values for shape detection to determine an order value that specifies dimensions of time series data represented in a frequency domain, according to an implementation.

FIG. 4B illustrates a plot showing an example of forecasted values for shape detection to determine an order value that specifies dimensions of time series data represented in a frequency domain, according to an implementation.

FIG. 5 illustrates an example of a method of forecasting time series data based on real-world recurrent pattern detection, according to an implementation.

FIG. 6 illustrates an example of a method of fine-tuning an order value based on decomposition of time series data into frequency components with random sampling and statistical averaging, according to an implementation.

### DETAILED DESCRIPTION

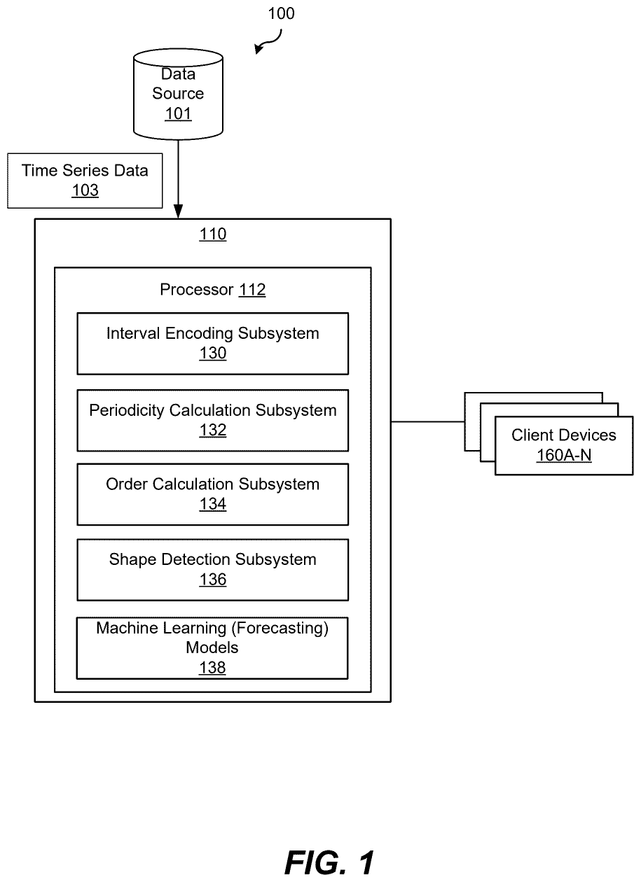

FIG. 1 illustrates an example of a system 100 for forecasting time series data based on real-world recurrent pattern detection, according to an implementation. As shown in FIG. 1, the system 100 may include one or more data sources 101 (illustrated as data sources 101A-N), a computer system 110, one or more client devices 160 (illustrated as client devices 160A-N), and/or other components.

A data source 101 may store and provide time series data 103. Time series data 103 is data having values over time. Each data value in time series data 103 may be associated with an increment of time such a seconds, minutes, days, weeks, months, or other unit of time. Various examples described herein throughout may refer to time series data in the context of deposits over time. In these examples, the system may detect recurrent patterns of deposit amounts, such as seasonality of deposits. However, the system may detect recurrent patterns of other types of time series data for forecasting may be modeled as well.

Forecasting time series data 103 may involve a machine learning model 138 (discussed below) trained to learn patterns in time series data 103 in order to make predictions on future time series data.

The computer system 110 may detect recurrent patterns from time series data through fine-tuned order determinations based on time-to-frequency domain transformations. The fine-tuned orders may be used to tune machine learning models to make predictions based on the time series data. In this context, tuning a machine learning model may refer to using order of frequency data specifically defined from time series data for training and executing the models to make more accurate forecasts based on recurrent patterns that are identified based on the order of frequency data. The order of frequencies in the transformed frequency domain of the time series may be used to identify important or relevant frequency components, which in turn may be used to identify recurrent patterns in the time series.

The computer system 110 may include one or more processors 112. A processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

As shown in FIG. 1, processor 112 is programmed to execute one or more computer program components. The computer program components may include software programs and/or algorithms coded and/or otherwise embedded in processor 112, for example. The one or more computer program components or features may include an interval encoding subsystem 130, a periodicity calculation subsystem 132, an order calculation subsystem 134, a shape detection subsystem 136, one or more machine learning models 138, and/or other components or functionality.

The interval encoding subsystem 130 may define intervals of the time series data 103 that improve sensitivity of detecting recurrent patterns around certain time periods. To illustrate, if weekly intervals of the time series data is used for forecasting, it may be difficult to detect recurrent patterns at the beginning or end of a month. In this example, a week may be defined as a 7-day interval as shown in Table 1 below.

Table 1. Weekly intervals (“Week”) are illustrated in which weeks are defined as a continuous 7 day period from week-to-week in a year. Only five weeks are shown for brevity.

TABLE 1

| Week | Week Number | Month |
|---|---|---|
| Jan 2-Jan 8 | 1 | January |
| Jan 9-Jan 15 | 2 | January |
| Jan 16-Jan 22 | 3 | January |
| Jan 23-Jan 29 | 4 | January |
| Jan 30-Feb 5 | 5 | January (2 Days) / February (5 Days) |
| . . . | . . . | . . . |

In a 7-day weekly interval, there may be occasions when a given interval (week) will span two months. As shown in Table 1, for example, week 5 will span both January and February. In these instance, recurrent patterns at the end of January and/or at the beginning of February may be difficult to detect since the time series data is merged into week 5 data. It should be noted that this issue may occur in intervals other than a weekly interval in which the interval spans multiple higher-order intervals (other than months), which will similarly reduce sensitivity of detecting recurrent patterns around these higher-order intervals (where a higher-order interval such as a month has multiple lower-order intervals such as weeks).

To address these issues, the interval encoding subsystem 130 may define intervals of the time series data 103 to ensure that the beginning and end of each higher-order interval are taken into account, improving the sensitivity of detecting recurrent patterns around these times periods. In particular, the interval encoding subsystem 130 may define an initial lower-level interval of a higher-level interval to start at the beginning of a higher-level interval and end at the ending of the higher-level interval. For example, the interval encoding subsystem 130 may define an initial weekly interval of January to start at the beginning of January and an ending weekly interval to end at the end of January. An example of such interval definition is illustrated in Table 2.

Table 2. Weekly intervals (“Week”) are illustrated in which weeks are defined to improve sensitivity for detecting recurrent patterns that occur at certain periods of time. Only five weeks are shown for brevity.

TABLE 2

| | Week | |
|---|---|---|
| Week | Number | Month |
| Jan 1-Jan 7 | 1 | January |
| Jan 8-Jan 15 | 2 | January |
| Jan 16-Jan 23 | 3 | January |
| Jan 24-Jan 31 | 4 | January |
| Feb 1-Feb 7 | 5 | February |
| . . . | . . . | . . . |

As shown in Table 2, if there is a recurrent pattern at the end of January and/or beginning of February, the weekly intervals will facilitate detection of these and similar recurrent patterns, in addition to any recurrent patterns that may occur in the middle of a given month.

To detect recurrent patterns, the computer system 110 may transform the time series data 103 (in the form of the weekly or other intervals) from a time-domain into a frequency-domain. However, doing so may require an appropriate periodicity to accurately render frequency-based components such as sine and cosine components. However, strictly using weekly or other types of intervals may inaccurately represent a period of interest. For example, if the period of interest is one year, and weekly intervals are used, a periodicity of one year will not be achieved because there are not exactly 52 weeks in a given year because of leap year. This may result in inaccurate detection of recurrent patterns that may occur year-over-year. Other time-domain anomalies may exist for periods other than a year as well.

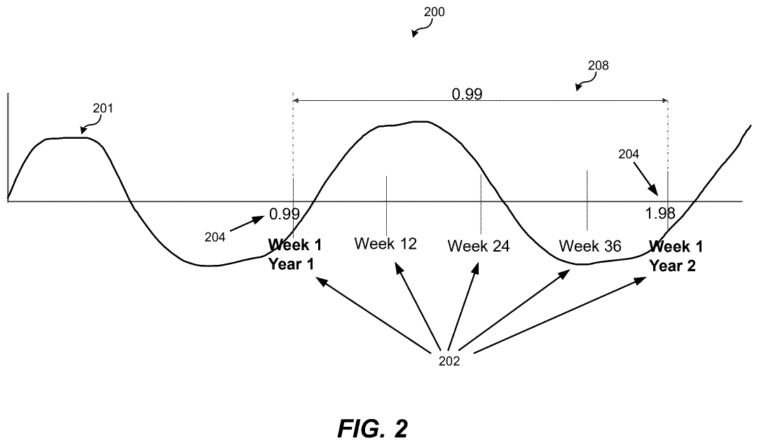

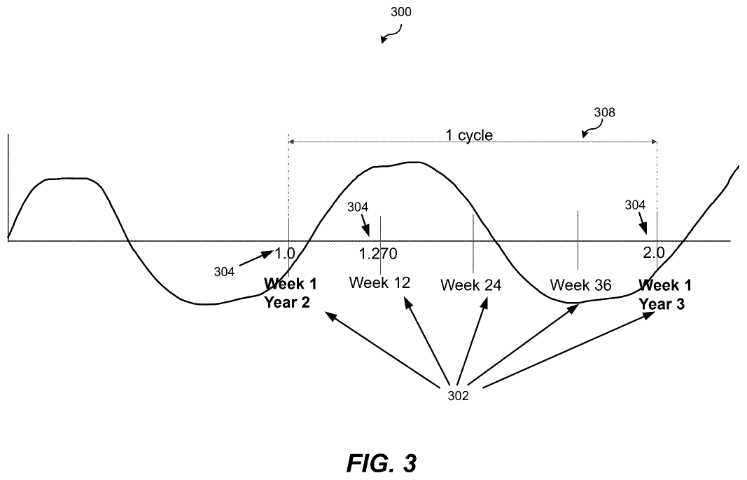

To illustrate how the computer system 110 may address this periodicity problem, reference will be made to FIG. 3 and the periodicity calculation subsystem 132 illustrated in FIG. 1. FIG. 2 illustrates a plot 200 showing an example of a periodicity of time series data, according to an implementation. FIG. 3 illustrates a plot 300 showing an example of a second periodicity of time series data having date values converted to non-date numeric values to generate waveform components that improve recurrent pattern for forecast modeling, according to an implementation.

The periodicity calculation subsystem 132 may convert each date-based value 202, 302 (illustrated in FIG. 2 as “Weeks, 1, 12, 24, and 36 of Year 1” and “Week 1 of Year 2” and FIG. 3 as “Weeks, 1, 12, 24, and 36 of Year 2” and “Week 1 of Year 3”) to a numeric value 204, 304 (illustrated in FIG. 2 as 0.99 and 1.98 and FIG. 3 as 1.0 and 2.0) to form periodicity 208, 308.

The numeric value 204, 304 may be used for frequency calculations for frequency components 201, 301 as sine or cosine waves. The frequency components 201, 301 may then be used to break time components (such as weeks) into frequency components (such as numeric values). Without the conversion for the frequency component 301, a given time point and its data value in the time series data 103 may not be used to accurately form periods, such as one year periods, making recurrent pattern detection inaccurate. After conversion, yearly values may differ by 1 unit (“1 cycle” illustrated in FIG. 3, unlike the periodicity of frequency component 201 illustrated in FIG. 2) so that sine and cosine values of frequency-based features such as Fourier features are the same for these points, resulting in exact replication by frequencies.

To illustrate, one way in which to determine periods may be based on Equation 1:

$$periods = \frac{df [ “ Month ” ] - pd . Timestamp ( “ 1900 - 01 - 01 ” ) ) . dt . days}{365.25} , \qquad ( 1 )$$

in which:
df[“Month”]: is a function that indicates a month from a DataFrame (containing months of the year);
pd.Timestamp(“1900-01-01”): Is a timestamp object representing the date “1900-01-01”;
dt.days is a function that counts number of days between the df[“Month”] and the timestamp representing 1900-01-01; and
365.25 represents the number of days in a year.

The approach according to Equation (1) may be unable to accurately form periods of interest, such as one year periods, making recurrent pattern detection prone to error. Converting the date-based values 202, 302 to numeric values 204, 304 may address this problem. An example of this conversion may be based on Equation (2):

$$periods = N + \frac{date . index + 1}{48} , \qquad ( 2 )$$

in which:
N represents the number of years of data from which the recurrent pattern is to be found; and
date.index represents the index of the date within a DataFrame or Series. The index is typically a sequence of integers, starting from 0.

Date-to-numeric conversion based on Equation 2 may ensure that each period (time which would be used as base frequency) to generate frequency components are spaced apart by a multiple of 1 frequency unit (such as periodicity of one year), so that sine or cosine waves cover data points at the same value from year-to-year, leading to improvement in break-up components.

The time series data 103 (which may have been encoded into an interval encoding and/or converted to numeric values) may be decomposed into frequency components using a default order value. The order calculation subsystem 134 may then fine-tune the order value used for recurrent pattern detection. The order value is a value for an order of frequencies in a transformed signal where the transformed signal is a result of the conversion of the time series data 103 from a time domain to a frequency domain. The order of frequencies refers to an arrangement and relationship between the different frequency components that make up the transformed signal. These frequency components represent the sinusoidal waves that contribute to the overall signal, and their order reflects how they are organized in terms of their frequency values. Examples of transformation techniques to transform the time series data 103 in a time domain to a frequency domain include, without limitation, a Fourier transform, Short-Time Fourier Transform, a Fractional Fourier Transform, a Wavelet Transform, and a Z-Transform.

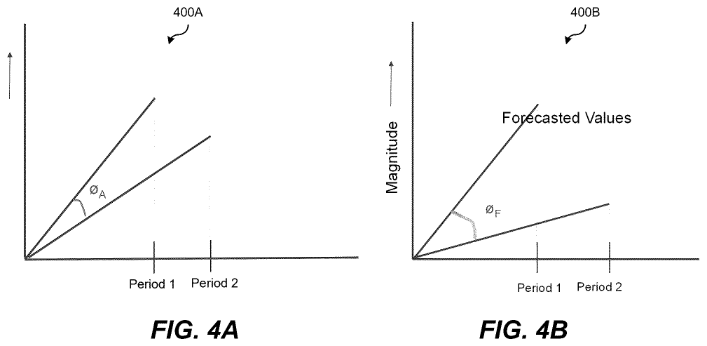

The following example will describe a Fourier transform for illustration. The Fourier transform is a technique that decomposes a signal such as the time series data 103 into its constituent frequencies. For example, the computer system 110 may use the Fourier transform to decompose the time series data 103 into its constituent frequencies. The future values of each frequency component are forecast using a forecasting model. The forecast values (examples of which are plotted in FIG. 4A) of the frequency components are recombined using the inverse Fourier transform to obtain the forecast for the time series data.

An input to the Fourier transform includes the order value that represents the order of frequencies. The order of frequencies follows a symmetric pattern around zero frequency. Positive frequencies increase in magnitude from zero to the Nyquist frequency, while negative frequencies decrease in magnitude from zero to the negative Nyquist frequency. This arrangement reflects the fact that sinusoidal waves can have either positive or negative frequencies, and their magnitudes represent their strength or amplitude. The Nyquist frequency, denoted by f_Nyquist, is the highest frequency that can be accurately represented by the Fourier transform given a specific sampling rate. Frequencies beyond the Nyquist frequency, known as aliasing artifacts, appear as lower-frequency components in the transformed signal. This phenomenon arises from the under-sampling of the original signal, leading to the overlapping of high-frequency components onto lower-frequency ones.

The order of frequency may be used to identify dominant (also referred to as “high”) frequencies that correspond to a recurrent pattern. In time series analysis, a Fourier transform may be used to decompose the time series into its constituent frequencies. The resulting spectrum, also known as the Fourier transform magnitude, displays the magnitude of each frequency component present in the original time series. The order of frequency in the spectrum may reveal one or more frequencies having the most significant contribution to the overall signal. Based on peaks in the spectrum, dominant seasonal frequencies can be identified. These frequencies correspond to the period of the seasonal pattern, indicating how often the seasonal fluctuations occur. For instance, if a time series exhibits annual seasonality, the dominant frequency in the spectrum will correspond to a period of one year. This means that there is a strong recurrent pattern that repeats every year. Similarly, if a time series exhibits quarterly seasonality, the dominant frequency will correspond to a period of three months, indicating a pattern that repeats every quarter. The order of frequencies may also provide information about the strength of the seasonal pattern. The higher the magnitude of a particular frequency component, the stronger its contribution to the overall signal and, consequently, the more pronounced the seasonal pattern associated with that frequency. By analyzing the order of frequencies in the Fourier transform, recurrent patters in time series data may be detected and analyzed. Understanding the recurrent (such as seasonal) pattern of a time series can improve the accuracy of forecasting models, as it allows for incorporating the seasonal component into the forecasting process. Such detected pattern may be encoded into the order value, which is fine-tuned by the order calculation subsystem 134.

For example, the order calculation subsystem 134 may decompose, using the default order value, the converted time series data into frequency-based features using a Fourier Transform. In a particular example, the order calculation subsystem 134 may take as input the converted time series data and corresponding sine and cosine components using the periodicity from the periodicity calculation subsystem 132. The order calculation subsystem 134 may use a Fourier transform with a default order value (N_order) of 10 to generate Fourier features based on the input to forecast values in the time series data 103. These Fourier features may include frequency components in a Fourier transform spectrum. The order calculation subsystem 134 may select the most relevant frequency components based on, for example, frequency magnitude, in which the top N (initially, the default N_order value) frequency components having the highest magnitudes are selected.

The order calculation subsystem 134 may further arrange the selected frequency components in descending order of magnitude. This optimized order, starting with the highest magnitude frequency component represents the order of frequencies that should be focused on during forecasting. The order calculation subsystem 134 may then generate forecasted values from actual values in the time series data 103. Such forecasting may be based on Monte Carlo Markov Chain (MCMC), Gaussian Mixture Model (GMM), and/or other techniques.

### Fourier-MCMC Based Forecasting

MCMC is a computational technique that simulates the behavior of a Markov chain, which is a sequence of random variables where each variable's value depends only on the value of the previous variable. MCMC is used to generate samples from a probability distribution, even if the distribution is too complex to sample from directly. In the context of time series forecasting, MCMC may be used to generate samples from the distribution of future values of the time series. This is done by simulating the evolution of the time series over time. The simulated time series is started at the current value of the time series, and then the next value in the series is sampled from the conditional distribution of the time series given the current value. This process is repeated until a desired number of future values have been generated.

The order calculation subsystem 134 may use MCMC to forecast the future values of the frequency components selected based on the Fourier components, following the optimized order. For instance, the order calculation subsystem 134 may use an MCMC to select the most relevant frequency components from the Fourier transform spectrum and adjust the order of frequency value accordingly. In particular, the order calculation subsystem 134 may iteratively generate a chain of random samples, converging towards the distribution of the frequency component magnitudes. From the generated samples, the system may identify the most significant frequency components.

In some implementations, for example, the order calculation subsystem 134 may use MCMC to generate a new candidate order of frequencies by randomly swapping or adding/removing frequency components from the current order. The order calculation subsystem 134 may evaluate the new candidate order: by calculating a goodness-of-fit metric for the candidate order, such as through a similarity metric (described with respect to FIGS. 4A and 4B). The order calculation subsystem 134 may accept or reject the new candidate order by comparing the goodness-of-fit metric of the candidate order to the current order. If the candidate order is better, accept it with a probability determined by the acceptance probability threshold. This process may be repeated for a predefined number of iterations until convergence is achieved. Convergence may be achieved when a stable distribution of frequency orders occurs, indicating that the space of possible orders has been sufficiently explored. After convergence, the order calculation subsystem 134 may then select the most relevant frequencies by analyzing the generated samples to identify the most frequently occurring frequency components. The most frequently occurring frequency components are identified because those components will remain consistent over the remaining samples. These most frequently occurring frequency components represent the most relevant ones and are used for subsequent analysis and forecasting.

### MCMC for Statistical Averaging

A normal distribution of Fourier features may be assumed with mean 0 and standard deviation 1. Seasonality (recurrent patterns) or autoregressive pattern may be determined as a dot product of Fourier features and the normal distribution. Trend may be given by Equation 3:

$$Trend = α + β * t , \qquad ( 3 )$$

in which:
α is a constant value representing a starting point of a trend line that intersects the y-axis when t=0;
β is a constant value that represents the slope of the trend line, indicating the change in y for every unit change in t; and
t is time.

Applying trend to seasonality yields a mean value (such as mean deposits or other value) in time series data.

### Fourier-GMM Based Forecasting

GMM is a statistical model that assumes that the data points in a dataset are generated by a mixture of a finite number of Gaussian distributions with unknown parameters. Each Gaussian distribution in the mixture is called a component, and each component represents a different subpopulation in the data, which may include the top N Fourier components identified from the Fourier transform. The parameters of a GMM are the means, variances, and weights of the individual Gaussian components. The means represent the centers of the Gaussian distributions, the variances represent the widths of the Gaussian distributions, and the weights represent the proportions of the data points that are generated by each Gaussian distribution. The order calculation subsystem 134 may use GMMs to model the distribution of the time series data at each time step, and then the mean of the GMM is used to forecast the future values of the time series data.

### Forecasting Based on the Fine-Tuned Order of Frequencies

Once the relevant frequency components are identified, the computer system 110 may apply statistical averaging to each of the relevant frequency components to smooth out noise and improve the signal-to-noise ratio. This may involve averaging the values of each frequency component within a specific time window or frequency range. The computer system 110 may convert the averaged frequency components back to the time domain to reconstruct the time series. In particular, the computer system 110 may recombine the averaged frequency components using an inverse Fourier transform to reconstruct the time series data. By doing so, the computer system 110 may synthesize smoothed frequency components back into the time domain, generating a smoothed and noise-reduced time series. The computer system 110 may then use the smoothed time series for forecasting. For example, the computer system 110 may apply a machine learning model 138 trained to predict future values. The machine learning model 138 may include a base version of the PROPHET model, an autoregressive integrated moving average (ARIMA) model, an exponential smoothing model, or others that may use the smoothed time series to predict future values.

The PROPHET model in particular may generate a partial Fourier sum for standard periods such as weekly, daily and yearly based on Equation (4):

$$s ( t ) = {\sum }_{n = 1}^{N} ( {a}_{n} cos ( \frac{2 π nt}{P} ) + {b}_{n} sin ( \frac{2 π nt}{P} ) ) \qquad ( 4 )$$

in which:
P is the regular period;
aₙ, bₙ are Fourier coefficients; and
N is the number of seasons.

### Shape Detection

The shape detection subsystem 136 may approximate the shapes of the forecasted values and the actual values. These shapes may be used to generate a similarity metric that estimates the similarity between forecasted values and the actual values. The similarity metric may be based on the angle and direction change of an interval such as the angle and direction of a weekly change. For example, the shape detection subsystem 136 may determine an angle and direction of weekly change of a value in the time series data 103 being forecasted for all weeks in the time series data. To illustrate, the value in the time series data 103 will be described as deposits of a financial institution and the weekly change refers to weekly change in deposits with reference to FIGS. 4A and 4B.

The shape detection subsystem 136 may calculate the angle and direction of weekly change for actual deposits for all weeks in the time series data 103. The shape detection subsystem 136 may calculate the angle and direction of weekly change for forecasted deposits (Seasonality) for all weeks.

The shape detection subsystem 136 may calculate an angle similarity metric based on the Mean Absolute Error (“MAE”) between the angle of weekly change for the actual values (ϕ_{A}) and the angle of weekly change for the forecasted values (ϕ_{F}). This MAE will be referred to as MAE (ϕ_{A}, ϕ_{F}). Similarly, the order calculation subsystem 134 may calculate a directional similarity metric based on the directionality of (ϕ_{A}, ϕ_{F}) according to the function: Count_Match (Dir(ϕ_{A}), Dir(ϕ_{F})) in which matches in directionality between the direction of weekly change of actual values matches the direction of weekly change of forecasted values. The MAE (ϕ_{A}, ϕ_{F}) and Count_Match (Dir(ϕ_{A}), Dir(ϕ_{F})) similarity metrics are used as measures of error between actual and forecasted values.

Table 3 shows an example of mean absolute percentage error (MAPE) using various data points, showing improvement of the frequency-based approach described herein versus a baseline using ARIMA without the frequency-based approach.

TABLE 3

| | Frequency- | | |
|---|---|---|---|
| | based | | |
| | approached | | |
| | described | ARIMA | |
| | herein | results | |
| | MAPE) | (MAPE) | Year |
| Total | 3.12 | 7.21 | 2022 |
| Total | 1.96 | 4.63 | 2023 (till September) |
| Time series dataset 1 | 3.49 | 5.68 | 2022 |
| Time series dataset 1 | 2.09 | 4.6 | 2023 (till September) |
| Time series dataset 2 | 3.65 | 4.59 | 2022 |
| Time series dataset 2 | 1.85 | 3.44 | 2023 (till September) |
| Time series dataset 3 | 6.43 | 7.4 | 2022 |
| Time series dataset 3 | 4.39 | 14.46 | 2023 (till September) |
| Time series dataset 4 | 11.63 | 22.9 | 2022 |
| Time series dataset 4 | 3.7 | 13.6 | 2023 (till September) |

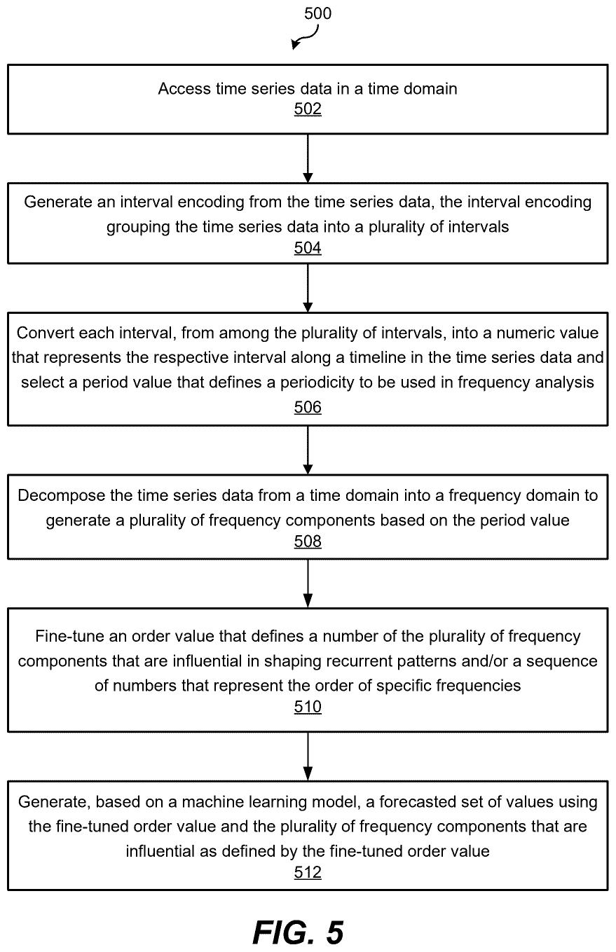

FIG. 5 illustrates an example of a method 500 of forecasting time series data based on real-world recurrent pattern detection, according to an implementation. At 502, the method 500 may include accessing time series data in a time domain. The time series data may span a plurality of months (may include a time series that includes data for multiple calendar, fiscal, or other types of months). At 504, the method 500 may include generating an interval encoding from the time series data, the interval encoding grouping the plurality of data into a plurality of intervals. The interval encoding defines the plurality of intervals so that, for each month, from among the plurality of months, a start interval in a given month begins with a first day of the month and an end interval for the given month ends with the last day of the month. It should be noted that, as described with respect to the interval encoding subsystem 130, the interval encodings may be encoded based on time periods other than months (where such interval encodings may be lower-level intervals based on higher-level intervals).

At 506, the method 500 may include converting each interval, from among the plurality of intervals, into a numeric value that represents the respective interval along a timeline in the time series data and select a period value that defines a periodicity to be used in frequency analysis, the period value defining a first numeric value to a second numeric value for the frequency analysis.

At 508, the method 500 may include decomposing the time series data from a time domain into a frequency domain to generate a plurality of frequency components based on the period value. At 510, the method 500 may include fine-tuning an order value that defines a number of the plurality of frequency components that are influential in shaping recurrent patterns and/or a sequence of numbers that represent the order of specific frequencies. At 512, the method 500 may include generating, based on a machine learning model (such as machine learning model 138), a forecasted set of values using the fine-tuned order value and the plurality of frequency components that are influential as defined by the fine-tuned order value.

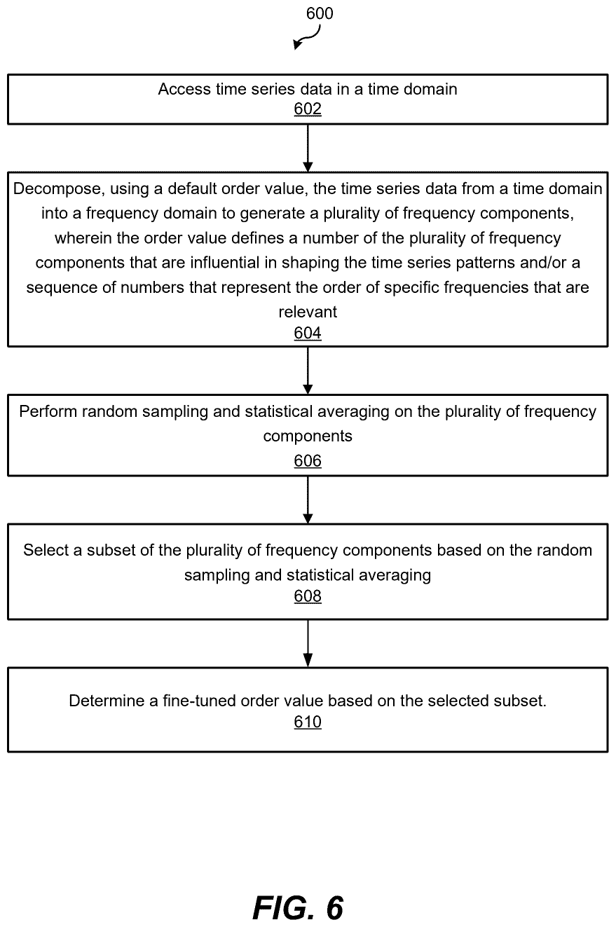

FIG. 6 illustrates an example of a method 600 of fine-tuning an order value based on decomposition of time series data 103 into frequency components with random sampling and statistical averaging, according to an implementation.

At 602, the method 600 may include accessing time series data (such as time series data 103) in a time domain. At 604, the method 600 may include decomposing, using a default order value (such as N_order=10), the time series data from a time domain into a frequency domain to generate a plurality of frequency components. The order value defines a number of the plurality of frequency components that are influential in shaping recurrent patterns and/or a sequence of numbers that represent the order of specific frequencies (such as those that are relevant). These relevant features may be influential and may reflect recurrent patterns in the time series data.

At 606, the method 600 may include performing random sampling and statistical averaging on the plurality of frequency components. At 608, the method 600 may include selecting a subset of the plurality of frequency components based on the random sampling and statistical averaging. For example, the subset may be selected by the order calculation subsystem 134 based on the Fourier-MCMC based forecasting described herein. At 610, the method 600 may include determining a fine-tuned order value based on the selected subset.

Processor 112 may be configured to execute or implement 130, 132, 134, 136, and 138 by software; hardware; firmware; some combination of software, hardware, and/or firmware; and/or other mechanisms for configuring processing capabilities on processor 112. It should be appreciated that although 130, 132, 134, 136, and 138 are illustrated in FIG. 1 as being co-located in the computer system 110, one or more of the components or features 130, 132, 134, 136, and 138 may be located remotely from the other components or features. The description of the functionality provided by the different components or features 130, 132, 134, 136, and 138 described below is for illustrative purposes, and is not intended to be limiting, as any of the components or features 130, 132, 134, 136, and 138 may provide more or less functionality than is described, which is not to imply that other descriptions are limiting. For example, one or more of the components or features 130, 132, 134, 136, and 138 may be eliminated, and some or all of its functionality may be provided by others of the components or features 130, 132, 134, 136, and 138, again which is not to imply that other descriptions are limiting. As another example, processor 112 may include one or more additional components that may perform some or all of the functionality attributed below to one of the components or features 130, 132, 134, 136, and 138.

The datastores (such as 101) may be a database, which may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The datastores may include cloud-based storage solutions. The database may store a plurality of types of data and/or files and associated data or file descriptions, administrative information, or any other data. The various datastores may store predefined and/or customized data described herein.

Each of the computer system 110 and client devices 160 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The computer system 110 and the one or more client devices 160 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more of the client devices 160. The data conveying the predictions may be a user interface generated for display at the one or more client devices 160, one or more messages transmitted to the one or more client devices 160, and/or other types of data for transmission. Although not shown, the one or more client devices 160 may each include one or more processors, such as processor 112.

The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIGS. 1, 4 and 6.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access time series data in a time domain, the time series data spanning a plurality of months;
generate an interval encoding from the time series data, the interval encoding grouping the time series data into a plurality of intervals, wherein the interval encoding defines the plurality of intervals so that, for each month, from among the plurality of months, a start interval in a given month begins with a first day of the month and an end interval for the given month ends with a last day of the month;
convert each interval, from among the plurality of intervals, into a numeric value that represents the respective interval along a timeline in the time series data and select a period value that defines a periodicity to be used in frequency analysis, the period value defining a first numeric value to a second numeric value for the frequency analysis;
decompose the time series data from a time domain into a frequency domain to generate a plurality of frequency components based on the period value;
fine-tune an order value that defines a number of the plurality of frequency components that are influential in shaping recurrent patterns and/or a sequence of numbers that represent the order of specific frequencies; and
generate, based on a machine learning model, a forecasted set of values using the fine-tuned order value and the plurality of frequency components that are influential as defined by the fine-tuned order value.

2. The system of claim 1, wherein to fine-tune the order value, the processor is further programmed to:
use a Monte Carlo Markov Chain (MCMC) to perform random sampling and statistical averaging on the plurality of frequency components; and
select a subset of the plurality of frequency components based on the random sampling and statistical averaging.

3. The system of claim 2, wherein the processor is programmed to:
use a default order value to analyze the plurality of frequency components, wherein the MCMC is used to determine a fine-tuned order value different from the default order value.

4. The system of claim 1, wherein to fine-tune the order value, the processor is further programmed to:
identify one or more densities in the time series data based on a Gaussian Mixed Model, wherein each density of the one or more densities corresponds to a respective season that impacts forecasting.

5. The system of claim 1, wherein the processor is further programmed to:
perform shape detection based on the forecasted set of values and actual values from the time series data; and
generate a similarity metric based on the shape detection, wherein the similarity metric provides an estimate of similarity between the forecasted set of values and the actual values.

6. The system of claim 5, wherein to generate the similarity metric, the processor is further programmed to:
for each interval in the plurality of intervals:
determine a first angle of change from the interval to a next interval in the actual values;
determine a second angle of change from the interval to the next interval in the forecasted values; and
determine an angle similarity metric based on first angles of change and second angles of change based on a Mean Absolute Error between the first angles of change and the second angles of change.

7. The system of claim 5, wherein to generate the similarity metric, the processor is further programmed to, for each interval in the plurality of intervals:
determine a first direction of change from the interval to a next interval in the actual values;
determine a second direction of change from the interval to the next interval in the forecasted values; and
determine a direction similarity metric based on the first direction of change, the second direction of change, and a count match function that counts matches in directionality between the direction of weekly change of actual values matches the direction of weekly change of forecasted values.

8. The system of claim 5, wherein to generate the similarity metric, the processor is further programmed to:
determine an angle similarity metric;
determine a direction similarity metric; and
generate the similarity metric based on the angle similarity metric and the direction similarity metric.

9. The system of claim 1, wherein the numeric value is used to define a single unit of periodicity.

10. The system of claim 1, wherein the time series data comprises deposit amounts of one or more financial accounts over time.

11. A method, comprising:
accessing, by a processor, time series data in a time domain, the time series data spanning a plurality of months;
generating, by the processor, an interval encoding from the time series data, the interval encoding grouping the time series data into a plurality of intervals, wherein the interval encoding defines the plurality of intervals so that, for each month, from among the plurality of months, a start interval in a given month begins with a first day of the month and an end interval for the given month ends with a last day of the month;
converting, by the processor, each interval, from among the plurality of intervals, into a numeric value that represents the respective interval along a timeline in the time series data and select a period value that defines a periodicity to be used in frequency analysis, the period value defining a first numeric value to a second numeric value for the frequency analysis;
decomposing, by the processor, the time series data from a time domain into a frequency domain to generate a plurality of frequency components based on the period value;
fine-tuning, by the processor, an order value that defines a number of the plurality of frequency components that are influential in shaping recurrent patterns and/or a sequence of numbers that represent the order of specific frequencies; and
generating, by the processor, based on a machine learning model, a forecasted set of values using the fine-tuned order value and the plurality of frequency components that are influential as defined by the fine-tuned order value.

12. The method of claim 11, wherein fine-tuning the order value comprises:
using a Monte Carlo Markov Chain (MCMC) to perform random sampling and statistical averaging on the plurality of frequency components; and
selecting a subset of the plurality of frequency components based on the random sampling and statistical averaging.

13. The method of claim 12, further comprising:
use a default order value to analyze the plurality of frequency components, wherein the MCMC is used to determine a fine-tuned order value different from the default order value.

14. The method of claim 11, wherein fine-tuning the order value comprises:
identifying one or more densities in the time series data based on a Gaussian Mixed Model, wherein each density of the one or more densities corresponds to a respective season that impacts forecasting.

15. The method of claim 11, further comprising:
performing shape detection based on the forecasted set of values and actual values from the time series data; and
generating a similarity metric based on the shape detection, wherein the similarity metric provides an estimate of similarity between the forecasted set of values and the actual values.

16. The method of claim 15, wherein generating the similarity metric comprises:
for each interval in the plurality of intervals:
determining a first angle of change from the interval to a next interval in the actual values;
determining a second angle of change from the interval to the next interval in the forecasted values; and
determining an angle similarity metric based on first angles of change and second angles of change based on a Mean Absolute Error between the first angles of change and the second angles of change.

17. The method of claim 15, wherein generating the similarity metric further comprises:
determining a first direction of change from the interval to a next interval in the actual values;
determining a second direction of change from the interval to the next interval in the forecasted values; and
determining a direction similarity metric based on the first direction of change, the second direction of change, and a count match function that counts matches in directionality between the direction of weekly change of actual values matches the direction of weekly change of forecasted values.

18. The method of claim 15, wherein generating the similarity metric comprises:
determining an angle similarity metric;
determining a direction similarity metric; and
generating the similarity metric based on the angle similarity metric and the direction similarity metric.

19. The method of claim 11, wherein the numeric value is used to define a single unit of periodicity.

20. A non-transitory computer readable medium storing instructions that, when executed by a processor, programs the processor to:
access time series data in a time domain;
decompose, using a default order value, the time series data from a time domain into a frequency domain to generate a plurality of frequency components, wherein the order value defines a number of the plurality of frequency components that are influential in shaping recurrent patterns and/or a sequence of numbers that represent the order of specific frequencies that are relevant;
perform random sampling and statistical averaging on the plurality of frequency components;
select a subset of the plurality of frequency components based on the random sampling and statistical averaging; and
determine a fine-tuned order value based on the selected subset.
